(19) United States
(12) Patent Application Publication
(10) Pub. No.: US 2013/0024296 A1
(43) Pub. Date: Jan. 24, 2013

(54) Optimizing Usage and Maximizing Revenue Generation of Digital Advertisement

(71) Applicant: Clas Sivertsen, Lilburn, GA (US)

(72) Inventor: Clas Sivertsen, Lilburn, GA (US)

(21) Appl. No.: 13/188,960

(22) Filed: Jul. 22, 2011

(51) Int. Cl. G06Q 30/00

(52) U.S. Cl. 705/14.71; 705/14.69

(57) ABSTRACT

Technologies for providing a digital advertising system and a method for controlling the same are provided. The method includes setting a price for each time unit in a target time slot of a digital sign at least with reference to a usage rate. Advertisers for the time units are selected in response to requests received therefrom via a communication network to advertise in the target time slot. Content segments are received from the selected advertisers via the communication network, and content packages, each including at least one content segment and metadata related thereto, are generated and transmitted to the digital sign via the same or a different communication network. The usage rate is a function of the time units being used for advertising and all the available time units in the target time slot, all the time slots, or a subset of all of the time slots.

### TECHNICAL FIELD

The present disclosure is related to digital advertising on a digital sign. More particularly, a method and system is provided for optimizing the usage of digital signs in the system and for maximizing the generation of revenue for digital advertisements presented on the digital signs.

### BACKGROUND

Methods and systems have been proposed that facilitate transactions between vendors who own digital signs and buyers who are interested in placing advertisements on the digital signs. Some conventional methods and systems involve an auctioning process, in which buyers place bids and a winner is selected from among the buyers. Typically, the vendor sets the initial price of advertising on the digital sign and the price fluctuates according to how bids are placed on the digital signs.

However, with conventional methods, when an advertising system is first established, demand may be very low and may increase only slowly over time. This is particularly the case in view of the fact that advertising using digital signs is a relatively new way to advertise and many buyers may be apprehensive about paying for such a service. Conventional methods and systems do not use a pricing scheme that considers the possibility of a very low-demand and even zero-demand scenario. Even when some demand for an advertising system has been established, as a result of the way the initial and ongoing price of a digital sign is set, many buyers may feel that the price for a desired time slot is too high and therefore decide against placing an ad on the digital sign in the advertising system. Hence, some time slots may go unfilled, resulting in losses in advertising revenue for the vendor. Moreover, the overall value of the system may decline significantly if the number of unfilled time slots is excessive.

The small number of factors used to control price fluctuations of the digital signs in a conventional advertising system may also result in the price charged for a particular time slot being too low, even when the demand for the time slot is high. This also results in losses in revenue for the vendor.

Buyers also may suffer as a result of the way in which conventional methods and systems operate. For example, when the number of pedestrians that pass by a digital sign abruptly drops due various reasons (for example, bad weather, construction, or change in traffic patterns), buyers may be charged less to reflect the reduction in traffic around the digital sign. In some instances, buyers may withdraw their ads from a digital sign after realizing that the target viewers in the area of the digital sign has decreased and that they are still being charged a price that assumes a higher number of pedestrians.

It is with respect to these considerations and others that the present disclosure has been made.

### SUMMARY

In one embodiment, a method is provided for controlling a digital advertising system that includes at least one digital sign having a plurality of time slots for advertising. The method includes setting a price for each of a plurality of time units in a target time slot of the digital sign at least with reference to a usage rate. Advertisers for the time units in the target time slot are selected in response to requests received from the advertisers via a communication network to advertise in the target time slot. Content packages are generated in response to receiving content segments from the selected advertisers via the communication network, wherein each content package includes at least one content segment and metadata related to the content segment. The content packages are transmitted to the digital sign via the same or a different communication network. In this embodiment, the usage rate is a function of the time units being used for advertising by one of: the advertisers and all the available time units in the target time slot, all the time slots, or a subset of all of the time slots.

In still an additional embodiment, a method provides for controlling a digital advertising system that includes at least one digital sign having a plurality of time slots for advertising. The method for controlling a digital advertising system according to this embodiment includes setting an initial price for each of a plurality of time units in a target time slot of the digital sign with reference to one or both of the cost of ownership of the digital sign and the cost incurred to operate the digital advertising system. An ongoing price for each of the time units in the target time slot is set by an auctioning process. Advertisers with the highest bids for the time units in the target time slot are selected. The bids from the advertisers are received via a communication network. Content segments received from the selected advertisers via the communication network and content packages are generated using the content segments. Each content package includes at least one content segment and metadata related to the content segment. The content packages are transmitted to the digital sign via the same or a different communication network.

In another exemplary embodiment, a digital advertising system includes at least one digital sign having a plurality of time slots for advertising, and an advertising server configured to set a price for each of a plurality of time units in a target time slot of the digital sign at least with reference to a usage rate and select advertisers for the time units in the target time slot in response to requests received from the advertisers via a communication network to advertise in the target time slot. The server is also configured to generate content packages in response to receiving content segments from the selected advertisers via the communication network, wherein each content package includes at least one content segment and metadata related to the content segment, and transmit the content packages to the digital sign via the same or a different communication network, wherein the usage rate is a function of the time units being used for advertising by advertisers and all the available time units in the target time slot, all the time slots, or a subset of all of the time slots

Yet another exemplary embodiment may provide a computer-readable storage medium having computer readable instructions stored thereupon that, when executed by a computer, may cause the computer to set a price for each of a plurality of time units in a target time slot of the digital sign at least with reference to a usage rate, the plurality of time slots associated with a digital sign in a digital advertising system, and select advertisers for the time units in the target time slot in response to requests received from the advertisers via a communication network to advertise in the target time slot. The instruction further cause the computer to generate content packages in response to receiving content segments from the selected advertisers via the communication network, wherein each content package includes at least one content segment and metadata related to the content segment, and transmit the content packages to the digital sign via the same or a different communication network, wherein the usage rate is a function of the time units being used for advertising by advertisers and all the available time units in the target time slot, all the time slots, or a subset of all of the time slots.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a block diagram illustrating various components of a digital advertising system according to an embodiment of the present disclosure;

FIGS. 2A and 2B are block diagrams of a digital sign and an advertising server respectively according to an embodiment of the present disclosure; and

FIG. 3 is a flow diagram illustrating a method for controlling a digital advertising server according to an embodiment of the present disclosure.

### DETAILED DESCRIPTION

Embodiments disclosed herein provide a method and system for optimizing the usage of digital signs in the system and for maximizing revenue generation of digital advertisements presented on the digital signs. In the following detailed description, references are made to the accompanying drawings that form a part hereof, and in which are shown by way of illustration specific embodiments or examples. Referring now to the drawings, in which like numerals represent like elements through the several figures, aspects various embodiments will be described.

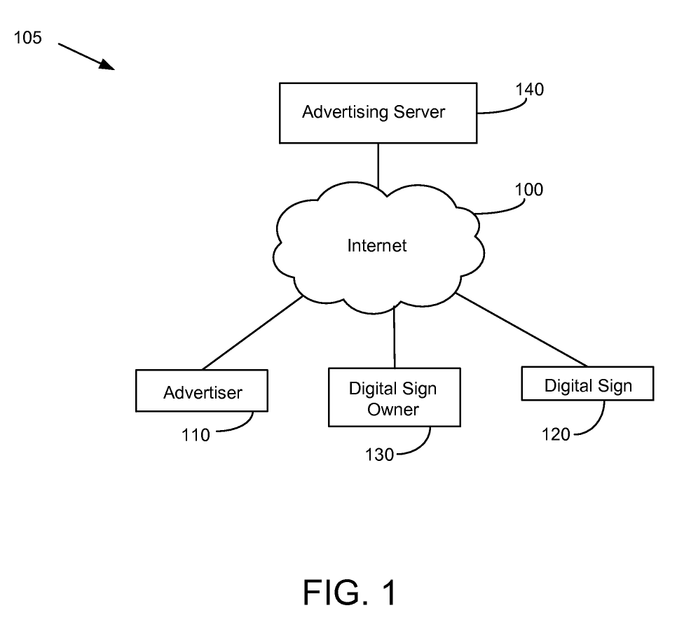

Referring now to FIG. 1, a block diagram will be described that illustrates a digital advertising system 105 according to one embodiment. The digital advertising system 105 comprises an advertiser 110, a digital sign (“DS”) 200, and a DS owner 130 that are connected to an advertising server 140 via the Internet 100. It should be appreciated that while the Internet 100 is used herein as a means of communication with the advertising server 140, other suitable communication networks, such as a WLAN (wireless local area network) or a cellular telephone network, may also be used. Moreover, one type of a communication network may be used to enable communication between the advertiser 110 and the advertising server 140 and between the DS owner 130 and the advertising server 140, and another type of communication network may be used to enable communication between the digital sign 200 and the advertising server 140. For example, a distributed public network, such as the Internet 100, may be used to enable communication between the advertiser 110 and the advertising server 140 and between the digital sign owner 130 and the advertising server 140, and a private network, such as a WLAN, may be used to enable communication between the digital sign 200 and the advertising server 140.

The advertiser 110 may be an individual user or a company, such as an advertising company desiring to place advertisements. The advertiser 110 uploads at least one content segment of an advertisement to the advertising server 140 via the Internet 100. The content segment will become part of a content package generated by the advertising server 140 and which includes the content segment and metadata. The advertisement content segment may include, for example, a video clip, a picture, a digital poster, a 3D (three-dimensional) image, a presentation, an animation, a song or music, or some combination thereof.

The advertiser 110 also provides other advertising related information to the advertising server 140. Such other information may include one or more of the following: identification of which digital sign(s) 200 on which the content segment (in embodiments including a plurality of digital signs 200) is to be presented, the desired time slot(s) to present the content segment, the maximum that the advertiser 110 is willing to pay per time unit, the total budget for the particular advertising campaign, how long it is desired to run the advertising campaign, when it is desired to start the advertising campaign, and whether and how repeated presentation of the content segment during a time slot is desired.

It should be appreciated that “time slot” as used herein may refer to various different time periods. For example, “time slot” may refer to hour-long periods in a 24-hour period of time, or may refer to time periods that split up a 24-hour period of time according to pedestrian activity in a city, such as in the following: 7 a.m.-9 a.m., 9 a.m.-11 a.m., 11 a.m.-1 p.m., 1 p.m.-5 p.m., 5 p.m.-7 p.m., 7 p.m.-110 p.m., and 110 p.m.-7 a.m., with each of these time periods representing a “time slot.” Typically, there are a plurality of time units in a time slot.

In some embodiments, the advertising server 140 creates a web interface through which the advertiser 110 provides the advertising related information as described above. The advertiser can upload the content segment and indicate the aforementioned parameters.

The digital sign 200 is the device capable of presenting the advertising, which typically includes a visual display and/or audible speakers. The digital sign 200 can be an integrated unit comprising various control and communication capabilities for receiving advertising content and controlling its presentation. In other embodiments, the digital sign comprises a display unit (such as a plasma display monitor) and a control/communication unit that is separately housed and connected for driving the display screen, speakers, sensors, etc. The digital sign can be a device dedicated to providing advertising (e.g., an electronic billboard) or it can provide other (non-advertising) functions (e.g., a mobile phone, tablet computer, etc.).

The DS Sign Owner represents the owner of the digital sign and may provide information regarding the digital sign, it location and type, and operating information. As will be seen, the advertising server maintains such information to enable advertisers to effectively bid on time slots for a DS or group of DS.

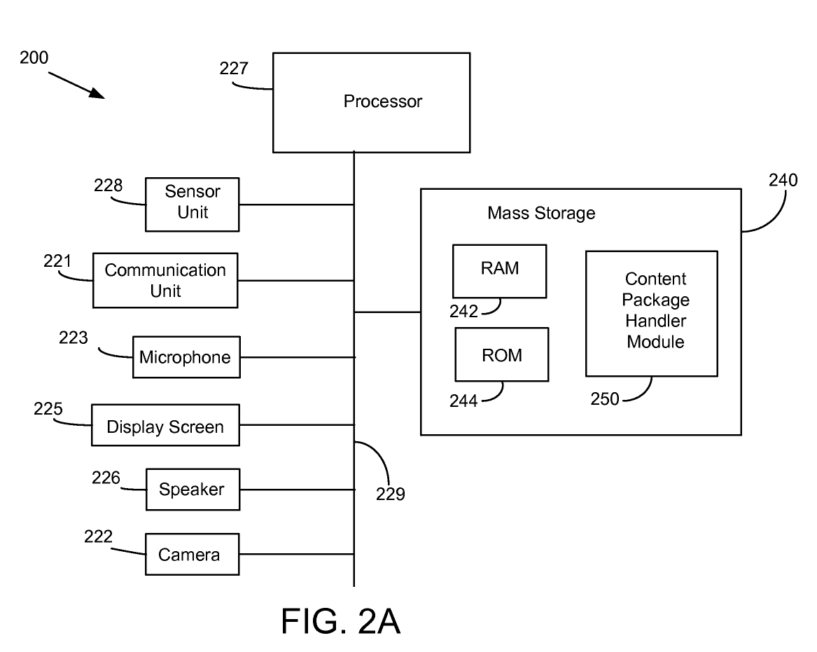

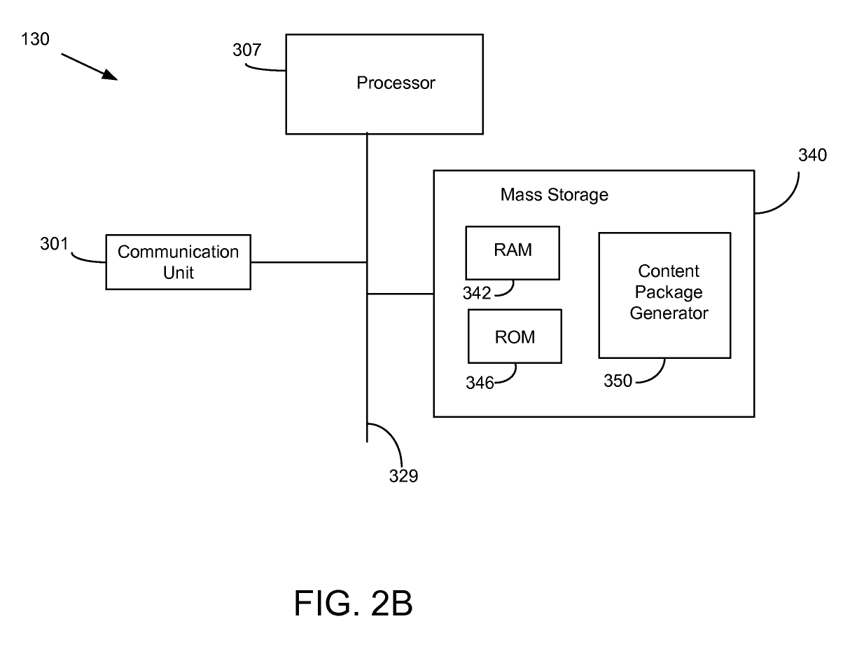

Referring to FIG. 2, one embodiment of the digital sign is illustrated. The digital sign 200 can comprise a communication unit 221, a camera 222, a microphone 223, a memory 240, a display screen 225, a speaker 260, a processor 227, and a sensor unit 280. The digital sign 200 may be any type of monitor capable of displaying digital content, such as a monitor or plasma display, liquid crystal display (LCD) monitor or an organic light-emitting diode (OLED) monitor, or may be a device that is typically used for computing/communication purposes, such as a mobile phone or a tablet computer. The digital sign can be dedicated for providing advertising (e.g., an electronic outdoor billboard), or it can be a device which provide other functions as well (e.g., a mobile phone).

The communication unit 221 enables communication with the advertising server 140 using the previously identified communication networks to receive the content package therefrom, and to transmit information thereto as will be described below. In one embodiment, communication may take place via the Internet 100. The communication unit 221 may comprise a wireless transceiver (not shown) for radio frequency communication, microwave communication, or infrared (IR) short-range communication, and/or a port unit (not shown) for communication using a line technology, such as cable or ADSL (asymmetric digital subscriber line).

The camera 222 captures images in front and/or around the digital sign 200, and outputs a corresponding image signal. The camera can be used, for example, to monitor individuals in the vicinity of the sign (potential advertisement viewers). The microphone 223 detects sound in the vicinity of the digital sign 200 and outputs a corresponding sound signal.

The mass storage 240 comprises RAM 242 and ROM 244, forms of volatile and non-volatile memory storage. The mass storage stores the content package received from the advertising server 140. The memory 240 may also store the image signal output by the camera 222 and the sound signal output by the microphone 223. Alternatively, through control by the processor 227, the image signal output by the camera 222 and the sound signal output by the microphone 223 may be transmitted to the advertising server 140 through the communication unit 221 and the Internet 100 after storage in the memory 240, or may be directly transmitted to the advertising server 140 through the communication unit 221 and the Internet 100. Additionally, through control by the processor 227, the memory 240 may store information related to content segments previously presented on the digital sign 200, such as which content segment were previously presented on the digital sign 200 and when these content segments were previously presented on the digital sign 200. The Mass Storage 240 also stores program instructions, such as content package handler module 250 which when executed by the processor 227 causes the digital sign to perform the procedures identified herein.

The display screen 225 visually presents the content segments as controlled by processor 227. The display screen 225 may be based on any display technology capable of presenting digital content, such as but not limited to liquid crystal display (LCD) technology, plasma display panel (PDP) technology, organic light-emitting diode (OLED) technology, vacuum fluorescent (VF) technology, and electronic paper technology.

The speaker 260 may also be used to present the content segment through control by the processor 227. The content segment may consist of audio information only, or may include audio components in addition to other forms of media. The speaker 260 may be used for providing the audio portion of the content segment.

The processor 227 controls the presentation of the content segment on the display screen 225, and through the speaker 260 (if required), with reference to the metadata in the content package. When the digital sign 200 has received a plurality of content segments from the advertising server 140, the processor 227 may utilize a scheduling mechanism as implemented in the content packaged handle module 250 to present the content segments on the display screen 225 and the speaker 260. In some embodiments, the processor 227 analyzes the image signal output by the camera 222 and the sound signal output by the microphone 223 to obtain demographic information. In other embodiments, as will be described below, the advertising server 140 obtains demographic information by analyzing the image signal output by the camera 222 and the sound signal output by the microphone 223. In embodiments where the processor 227 of the digital sign 200 obtains demographic information, the demographic information may be stored in the memory 240 before eventual transfer to the advertising server 140.

The processor 227 may be implemented as a conventional computer system, an embedded control computer, a laptop, or a server computer, a mobile device, a set-top box, a kiosk, a customized machine, or other hardware platform. The processor 227 may be a general purpose processor, a processor core, a multiprocessor, a multi-core processor, a graphics processor, a digital signal processing (“DSP”) processor, a customized computing device implemented within an application specific integrated circuit (“ASIC”), a customized computing device implemented within a field programmable gate array (“FPGA”), a customized computing device implemented within any type of programmable logic, a state machine, a reconfigurable processor, any other processing unit, or any combination or multiplicity thereof.

The processor 227 may be constructed from any number of transistors or other circuit elements, which may individually or collectively assume any number of states. More specifically, the processor 227 may operate as a state machine or finite-state machine. Such a machine may be transformed to a second machine, or a specific machine, by loading executable instructions contained within the program modules. These computer-executable instructions may transform the processor 227 by specifying how the processor 227 transitions between states, thereby transforming the transistors or other circuit elements constituting the processor 227 from a first machine to a second machine, wherein the second machine may be specifically configured to perform the operations disclosed herein. The states of either machine may also be transformed by receiving input from the communication unit 221, other peripherals, other interfaces, or one or more users. Either machine may also transform states, or various physical characteristics of various output devices such as printers, speakers, video displays, or otherwise.

Encoding the program modules, such as the content package handler module 250, may also transform the physical structure of the storage media. The specific transformation of physical structure may depend on various factors, in different implementations of this description. Examples of such factors may include, but are not limited to: the technology used to implement the storage media, whether the storage media are characterized as primary or secondary storage, and the like. For example, if the storage media are implemented as semiconductor-based memory, the program modules may transform the physical state of the semiconductor memory 240 when the software or firmware is encoded therein. For example, the software may transform the state of transistors, capacitors, or other discrete circuit elements constituting the semiconductor memory.

As another example, the storage media may be implemented using magnetic or optical technology such as hard drives or optical drives. In such implementations, the program modules may transform the physical state of magnetic or optical media, when the software is encoded therein. These transformations may include altering the magnetic characteristics of particular locations within given magnetic media. These transformations may also include altering the physical features or characteristics of particular locations within given optical media to change the optical characteristics of those locations. It should be appreciated that various other transformations of physical media are possible without departing from the scope and spirit of the present description.

It is also contemplated that the digital sign 200 may not include all of the components shown in FIG. 1, may include other components that are not explicitly shown in FIG. 1, or may utilize an architecture completely different than that shown in FIG. 1.

Returning to the other components shown in FIG. 2A, the sensor unit 280 includes a plurality of sensors (not shown), such as an accelerometer, a mechanical switch sensor, and a temperature sensor that detect various states and environmental conditions of the digital sign 200 and output corresponding detection signals. The detection signals may be output to the advertising server 140 or to the processor 227 of the digital sign 200. When the processor 227 receives the detection signals, the processor 227 may determine whether the security of the digital sign 200 has been compromised and output a corresponding security breach signal to the advertising server 140 via the communication unit 221. In some embodiments, the processor 227 performs control to keep a record of all possible security breaches of the digital sign 200 in the memory 240. The advertising server 140 may then obtain this record by outputting a corresponding instruction signal to the digital sign 200 to transmit the record to the advertising server 140.

FIG. 2B illustrates one embodiment of the advertising server 130. The advertising server comprises a processor 307, which can be of various forms which were identified above. The processor 307 communicates over a bus 329 with the communication unit 301, which provides connectivity to various communication networks, including but not limited to the Internet. The content segments are received using the communication unit 301, and are stored by the processor in the mass storage 340.

The mass storage 340 comprises RAM 342 and ROM 346, and can be of the various forms of mass storage as described previously. The mass storage also stores various program modules, which stores instructions that when executed, cause the processor to perform the procedures indicated herein. The stored program modules includes the content package generator, which can receive content from an advertiser and generated the content package comprising the metadata and then transmit the content package to the digital sign.

The advertising server may host a portal for allowing the digital sign owner to input information related to the digital sign. The DS owner 130 inputs information related to the digital sign 200 to the advertising server 140 via the Internet. The DS owner 130 may input information for use by the advertising server 140 to calculate cost of ownership of the digital sign 200. For example, the DS owner 130 may input one or more of the following: the postal code or GPS coordinates where the digital sign 200 is located, the retail price of the digital sign 200, land or real estate rental and taxes, and the cost of electricity (i.e., cost per kilowatt-hour for the area where the digital sign 200 is located). In some embodiments, the DS owner 130 may also input information related to the types of advertisements that are preferred or are not preferred to be presented on the digital sign 200. For example, the digital sign 200 that the DS owner 130 owns may be located in a store frequented by children, such as a store in an amusement park, and therefore, the digital sign owner 130 may prefer to avoid advertisements related to alcohol and smoking products. The advertising server 140 can provide a web interface through which the digital sign owner 130 provides the information as described above.

The operations of the advertising server 140 will now be described. The advertising server 140 provides information to the advertiser 110, which may be accomplished through a web interface as described above. For example, in embodiments including a plurality of digital signs 200, the advertising server 140 may provide information on the locations of the digital signs 200 (which may have been provided originally from the DS owner). In some embodiments, the advertising server 140 may allow the advertiser 110 to search locations of the digital signs 200, such as through a map display shown on a web interface.

Through connection to the digital sign 200 via the Internet 100, the advertising server 140 may determine the operational status, capabilities, capacity, and usage statistics of the digital sign 200. The advertising server 140 may also obtain information related to content segments previously presented on the digital sign 200 by accessing the memory 240 of the digital sign 200. This information may also be provided to the advertiser 110.

In some embodiments, the advertising server 140 may obtain information related to the security of the digital sign 200. That is, the advertising server 140 may receive the detection signals output by the sensor unit 280 and determine therefrom whether the security of the digital sign has been compromised. When it has been determined through the processor 227 of the digital sign 200 or through the advertising server 140 that the security of the digital sign 200 has been breached, this information may also be made available to the advertiser 110. In some embodiments, the advertising server 140 may also automatically alert an administrator or maintenance technician of the advertising server 140 that the security of the digital sign 200 has been compromised, such as through an alert message provided on the screen of the computer used to monitor and control the advertising server 140 and/or by sending an email or text message to the administrator or technician. The administrator may then dispatch appropriate personnel to the site of the digital sign 200 to check the security thereof, and then either re-authenticate the security state of the digital sign 200 if it is determined that it was a false alarm or take other appropriate action. The administrator may monitor and control the advertising server 140 through a computer as described above, or through some other device, such as a mobile phone.

The advertising server 140 may also provide information to the advertiser 110 related to which time slots are available for the digital sign 200, the present prices for the time slots, when the contracted period for each of the time slots ends, whether there have been any bids on the next period for each of the time slots, etc. Details related to the prices for the time slots, bidding for the time slots, contracted periods of the time slots, etc. will be described in greater detail below.

The advertising server 140 may also analyze the image signal output by the camera 222 of the digital sign 200 and the sound signal output by the microphone 223 of the digital sign 200 to obtain various types of information. In some embodiments, the advertising server 140 obtains demographic information of persons and/or vehicles in the vicinity of the digital sign 200 (i.e., of the viewers of the digital sign 200) using the image signal output by the camera 222 of the digital sign 200. For example, the advertising server 140 can determine the number of persons and/or vehicles passing by the digital sign 200 during a predetermined period (e.g., a 240-hour period or between 5 p.m. and 7 p.m.) using the image signal output by the camera 222 of the digital sign 200. As another example, using the image signal output by the camera 222, the advertising server 140 counts the number of times during a predetermined period that pedestrians look at the digital sign 200, and may also determine which content segment was being displayed and even which portion of the content segment was being displayed when the pedestrians looked at the digital sign 200, how long the pedestrians looked at the digital sign 200, etc. Eye detection or eye tracking techniques may be used by the advertising server 140 to obtain such information.

In some embodiments, the advertising server 140 may be capable of obtaining significantly more detailed demographic information through the camera 222 of the digital sign 200. For example, using facial recognition techniques, the sex ratio and even ethnic makeup of persons passing by or stopping in front of the digital sign 200 may be obtained. Further, using facial gesture recognition techniques, emotion recognition from the faces of pedestrians can be performed to, for example, gauge the reaction of pedestrians to presented content segment. As yet another example, using image processing techniques, the advertising server 140 may be able to determine how many male professionals looked at the digital sign 200 during presentation of a particular content segment by, for example, recognizing the image pattern of a suit coat, dress shirt, and tie combination.

The advertising server 140 may provide such demographic information to the advertiser 110. The advertiser 110 may find such demographic information extremely valuable in determining whether advertising is desired on the digital sign 200, how high to bid for a particular time slot, which digital sign(s) 200 to select, etc.

The advertising server 140 also performs operations to determine the prices of the time slots for the digital sign 200. In some embodiments, an initial price per time unit (“PPTU”) for each time slot of the digital sign 200 is set at zero. A time unit may be 15 seconds, 130 seconds, one minute, etc. This would be particularly useful when the digital advertising system has been newly established and demand for the digital signs 200 (assuming a plurality of digital signs 200) has not yet been created or is still developing. By setting the initial PPTU for each time slot of each digital sign 200 to zero, demand can be expected to be immediately generated and the PPTU can be adjusted as awareness of the digital advertising system develops.

In some embodiments, the advertising server 140 calculates the cost of ownership of the digital sign 200, and determines the initial PPTU for each time slot on the basis of the cost of ownership of the digital sign 200. As described above, the DS owner 130 may input information for use by the advertising server 140 in determining the cost of ownership of the digital sign 200, such as the postal code where the digital sign is located, the retail price of the digital sign 200 (which may be amortized over a predetermined time period), land or real estate rental and taxes, the cost of electricity, etc. By charging the advertiser 110 prices for the time slots that are a function of the cost of ownership of the digital sign 200, the digital sign owner 130 could be paid at least an amount to cover the cost to own the digital sign 200, thereby attracting more digital sign owners 130 to join the digital advertising system. In certain embodiments, the DS owner and the operation of the advertising server may be the same.

In some embodiments, the initial PPTU for each time slot may be determined by the advertising server 140 to be a function of the costs incurred by the advertising server 140 to operate the digital advertising system. Such costs incurred by the advertising server 140 may include the cost to store, upload, and download the content segments provided by the advertisers 110. This may be a certain amount when a cloud storage service provided by a third party is utilized and a different amount when the content segments are stored internally by the advertising server 140. The costs incurred by the advertising server 140 may further include operating expenses (rent, gas, electricity, wages, etc.), taxes, etc. In some embodiments, the initial PPTU for each time slot is determined by the advertising server 140 to be a function of both the cost of ownership of the digital sign 200 and the costs incurred by the advertising server 140 to operate the digital advertising system.

After the initial PPTU for a particular time slot is set, the advertising server 140 also performs operations to enable fluctuations in what will be referred to herein as an ongoing PPTU for the time slot (i.e., the PPTU for the time slot any time subsequent to when the initial PPTU of the time slot is set). In some embodiments, the advertising server 140 performs operations to allow fluctuations in the ongoing PPTU for the time slots of the digital sign 200 through an auctioning process, which will now be described. To simplify the explanation, it will be assumed that the ongoing PPTU is directed to a single time slot of, for example, 5 p.m.-6 p.m. of specified days. The time unit may be, for example, 130 seconds, and the time unit in the time slot may be sold for a time slot period of, for example, one week (7 days).

After the time slot is sold for a time slot period (which can be for a zero amount in embodiments where the initial PPTU is set at zero), the advertising server 140 accepts bids from advertisers 110 for time units in the time slot during the next time slot period. In some embodiments, the advertising server 140 sets the minimum price for the time units in a time slot during the next time slot period at the present price for the time units. In other embodiments, the advertising server 140 may start anew by setting the minimum price for the time units at zero or set it to be a function of either or both of the cost of ownership of the digital sign 200 and the costs incurred by the advertising server 140 to operate the digital advertising system.

After a predetermined time period, the advertising server 140 no longer accepts bids for the time unit in the time slot. The advertising server 140 then selects the highest bid as the winning bid. The winning bid is ideally above the minimum price, but may also be allowed to fall below the minimum price (when the minimum price is not zero). The time unit in the time slot is then assigned to the advertiser 110 that placed the winning bid, and this advertiser 110 is notified of this fact. After selecting the winning bids for all time units in the time slot, the advertising server 140 may then open up bidding for the next time slot period.

In embodiments including a plurality of digital signs 200, the advertising server 140 may perform operations to facilitate an auctioning process for a time unit of a particular time slot simultaneously for a subset of or for all of the digital signs 200. That is to say, advertisers 110 may simultaneously bid on all of the digital signs 200, or alternatively, on a subset of the digital signs 200 located in a particular area of a city, in a number of franchise stores of a particular region of a country, etc.

The advertising server 140 may then instruct the advertiser 110 with the winning bid to upload at least one content segment. For example, the advertising server 140 may send an email to the advertiser 110, after which the advertiser 110 may navigate the website created by the advertising server 140 to upload the desired content segment.

After receiving the content segment from the advertiser 110, the advertising server 140 creates metadata associated with the content segment. The metadata may include information of when the content segment is to be played. For example, the metadata may include information related to during which time unit of a particular time slot that the content segment is to be presented, or may include information with instructions to randomly present the content segment during any time unit of the particular time slot. The metadata may also include information related to whether the content segment is to be repeated for multiple time units in the time slot, as well as information related to the time slot period.

The advertising server 140 subsequently creates a content package containing the content segment and the metadata, and transmits the content package to the digital sign 200. As described above, the processor 227 of the digital sign 200 provides control to present the content segment on the display screen 225, and possibly also through the speaker 260, with reference to the metadata in the content package. In embodiments including a plurality of digital signs 200 and in which the advertising server 140 performs operations to facilitate an auctioning process simultaneously for a subset or all of the plurality of digital signs 200, the advertising server 140 transmits the content package to each designated digital sign 200.

In some embodiments, the advertising server 140 facilitates processes to allow each of the advertiser 110 and the digital sign owner 130 to set up a deposit account. The advertising server 140 then deducts the deposit account of the advertiser 110 by the amount of the winning bid. This may occur immediately after the winning bid is selected, after the content package is sent to the digital sign 200, after presenting of the content package is started (i.e., at the beginning of the time slot period), at the end of the time slot period, or any other agreed-upon time. The advertising server 140 also credits the deposit account of the digital sign owner 130 using a predetermined formula. This may occur immediately following deduction of the deposit account of the advertiser 110 or at a select time thereafter, such as at any one of the select times outlined above. In some embodiments, the deposit account of the digital sign owner 130 is credited an amount based on a percentage of the winning bid.

In some embodiments, the advertising server 140 performs operations to enable fluctuations in the ongoing PPTU for a time slot on the basis of external conditions at the digital sign 200, as determined by analyzing the image signal output by the camera 222 and/or the sound signal output by the microphone 223. For example, the advertising server 140 may determine that the weather where the digital sign 200 is located is poor and therefore reduce the PPTU for all time slots for the digital sign 200 during the period when the weather remains poor. When the advertiser 110 has already paid for a particular time slot, the deposit account of the advertiser 110 may be credited by an appropriate amount. The deposit account of the digital sign owner 130 may also be deducted by a similar amount. As another example, the advertising server 140 may determine from both the image and sound signals that construction is taking place in the vicinity of the digital sign 200 and similarly reduce the PPTU for all time slots for the digital sign 200 (or some of the time slots, such as during daylight hours when actual construction is taking place). When such external conditions are present at the digital sign 200, there is less foot traffic around the digital sign 200 and a reduction in the PPTU for all or some of time slots may be appropriate.

In some embodiments, the advertising server 140 presents a default advertisement on the digital sign 200 for any time unit of any time slot that has not been purchased by an advertiser 110. Moreover, after a digital sign 200 has been set up and before auctioning of the time units of the time slots has started, the advertising server 140 may present a default advertisement on the digital sign 200 for all the time units of all the time slots. The default advertisement may, for example, be related to the digital advertising system and may include information related to how advertisers 110 can advertise on the digital signs 200, such as the website and/or a telephone number to call for interested advertisers 110.

In some embodiments, the advertising server 140 calculates a usage rate for one or more digital signs 200 in the digital advertising system. The usage rate is related to the number of time units in a particular time slot for which advertisers 110 have been selected and the total number of time units in the time slot for one or more digital signs 200, or is related to the number of time units in all the time slots for which advertisers 110 have been selected and the total number of time units in all the time slots for one or more digital signs 200. For example, the usage rate may be a percentage obtained from the ratio between the number of time units in all the time slots for the digital signs 200 for which advertisers 110 have been selected and the total number of time units in all the available time slots for the digital signs 200.

The advertising server 140 may then perform control so that the prices for the time units of the time slots are set ensuring a minimum usage rate of the digital advertising system. For example, even when demand is high, the advertising server 140 may not allow the prices for the time units in the time slots to increase until the usage rate achieves a certain level of, for example, 80%. As another example, the advertising server 140 may reduce the prices for the time units in the early-hour time slots (e.g., 1 a.m. to 5 a.m.) to zero and raise these prices only minimally over time to ensure that the usage rate is maintained at a desired level, thereby allowing normal auctioning for the time slots where demand is high. As yet another example, the advertising server 140 may provide for free advertising on a digital sign 200 with a low demand after an advertiser 110 pays for a time unit in a time slot for a digital sign 200 with a high demand. As still yet another example, when the usage rate is below a first threshold level, such as when the digital advertising system is first set up, the prices for the time units of all the time slots may be set at zero, and when the usage rate is above the first threshold level, the prices for the time units of all or some of the time slots may be set to be a function of one or more of the usage rate, the cost of ownership of the digital sign 200, and the costs incurred by the advertising server 140 to operate the digital advertising system.

Such control may be beneficial when the digital advertising system is initially set up and when demand may be low. Moreover, since a high usage rate works favorably toward providing value to the overall digital advertising system and a low usage rate has the opposite effect, ensuring that the usage rate is maintained at or above a desired level is extremely important to maintaining the business viability of the digital advertising system.

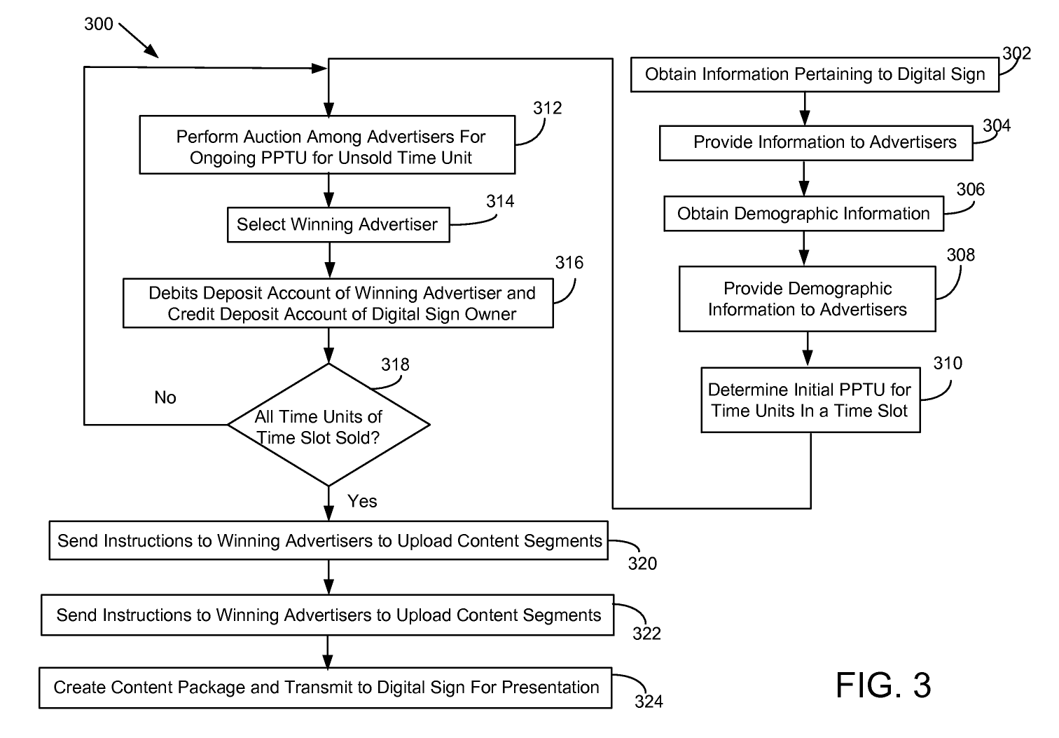

Referring to FIG. 3, a flow process 300 illustrates a method for controlling a digital advertising system in the advertising server according to an embodiment. It should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance requirements of the computing system. Accordingly, the logical operations described herein are referred to variously as operations, structural devices, acts, or modules. These operations, structural devices, acts and modules may be implemented in software, in firmware, in special purpose digital logic, and any combination thereof. It should also be appreciated that more or fewer operations may be performed, and in any order, than those shown and described herein.

It should be appreciated that the program modules disclosed herein, may include processing instructions that, when loaded into the processor 227 and executed, transform a general-purpose computing system into a special-purpose computing system customized to facilitate all, or part of, the operations disclosed herein. As detailed throughout this description, the program modules may provide various tools or techniques by which the digital sign 200 may participate within the overall systems or operating environments using the components, logic flows, and/or data structures discussed herein.

To simplify the explanation, it will be assumed that there are a plurality of advertisers 110, a single digital sign 200, and a single digital sign owner 130 of the digital sign 200. It should be appreciated that in real-life settings, there may be a plurality of each of the advertisers 110, the digital signs 200, and the digital sign owners 130.

The routine 300 begins at operation 302, where the advertising server 140 obtains information about the digital sign 200, as described above. For example, the advertising server 140 may probe the digital sign 200 to obtain information related to the operational status, capabilities, capacity, and usage statistics of the digital sign 200. In some embodiments, probing the digital sign 200 to obtain usage statistics may involve sending an instruction to the digital sign 200 to automatically transmit this information to the advertising server 140 via the Internet 110. The advertising server 140 may also obtain information related to the security of the digital sign 200 and related to availability of the time slots for the digital sign 200.

From operation 302, the routine 300 continues to operation 304, where the advertising server 140 provides this information to the advertisers 110. From operation 304, the routine 300 continues to operation 306, where the advertising server 140 obtains demographic information related to the digital sign 200. As described above, the advertising server 140 may analyze the image signal output by the camera 222 of the digital sign 200 to obtain the demographic information. In other embodiments, the processor 227 of the digital sign 200 may analyze the image signal output by the camera 222 to obtain the demographic information and then transmit the same to the advertising server 140 directly or after first storing the demographic information in the memory 240 thereof.

The routine 300 then continues to operation 308, where the advertising server 140 provides the demographic information to the advertisers 110. From operation 308, the routine 300 continues to operation 310, where the advertising server 140 determines the initial PPTU for the time units in a target time slot and in a target time slot period. As discussed above, the initial PPTU may be set at zero or may be a function or one or both of the cost of ownership of the digital sign 200 or the costs incurred by the advertising server 140 to operate the digital advertising system.

Subsequently, the routine 300 continues to operation 312, where the advertising server 140 facilitates auctioning among the advertisers 110 for the ongoing PPTU for one of the unsold time units in the target time slot. From operation 312, the routine 300 continues to operation 314, where a winning advertiser 110 is selected.

Next, at operation 316, the deposit account of the winning advertiser 110 is debited and the deposit account of the digital sign owner 130 is credited. As described above, the timing of debiting the deposit account of the winning advertiser 110 and the crediting the deposit account of the digital sign owner 130 may be varied. For example, such crediting and debiting of the deposit accounts of the winning advertiser 110 and the digital sign owner 130 may occur at the beginning of the time slot period.

The routine 300 then continues to operation 318, where a determination is made as to whether all of the time units of the target time slot of the target time slot period have been sold. If all of the time units of the target time slot of the target time slot period have not been sold, the routine 300 returns to operation 312, where, as described above, auctioning for one of the unsold time slots in the target time slot is started by the advertising server 140.

If, at operation 318, all of the time units of the target time slot of the target time slot period have been sold, the routine 300 continues to operation 320, where the winning advertisers 110 are instructed to upload content segments. As an example, the advertising server 140 may send an email message to each winning advertiser 110 to upload a content segment(s), after which each winning advertiser 110 uses a website set up by the advertising server 140 to perform this task.

From operation 320, the routine 300 continues to operation 322, where, in response to receiving content segments from the winning advertisers 110, the advertising server 140 creates content packages, each including a content segment(s) and metadata related to the content segment(s) from each winning advertiser 110. In operation 324 the advertising server sends the content packages to the digital sign 200.

Once the digital sign 200 receives the content segments in the content packages with reference to the metadata, the digital sign presents the advertising during the target time slot and for the duration of the target time slot period.

The various embodiments described above are provided by way of illustration only and should not be construed to limit the invention. Those skilled in the art will readily recognize various modifications and changes that may be made without following the example embodiments and applications illustrated and described herein, and without departing from the true spirit and scope of the present invention, which is set forth in the following claims.

What is claimed is:

1. A method for controlling a digital advertising system comprising at least one digital sign having a plurality of time slots for presenting advertising, the method comprising:
setting a price for each of a plurality of time units in a target time slot of the digital sign at least with reference to a usage rate;
selecting advertisers for the time units in the target time slot by a processor in response to requests received from the advertisers via a communication network to advertise in the target time slot;
generating content packages by the processor in response to receiving content segments from the selected advertisers via the communication network wherein each content package includes at least one content segment and metadata related to the content segment; and
transmitting the content packages by the processor to the digital sign via the same or a different communication network,
wherein the usage rate is a function of the time units used for advertising by one of advertisers and all the available time units in the target time slot, all the time slots, and a subset of all of the time slots.

2. The method of claim 1, wherein the digital advertising system comprises a plurality of digital signs, and the usage rate is a function of the time units being used by one of advertising by advertisers and all the available time units in the target time slot, all the time slots, and a subset of all of the time slots for all or a subset of all of the digital signs.

3. The method of claim 1, wherein the price of the time units in the target time slot is set at zero when the usage rate is below a threshold level.

4. The method of claim 1, further comprising:
obtaining information of the digital sign by one or more of probing the digital sign and receiving information from the owner of the digital sign; and
providing the information of the digital sign to advertisers before receiving the requests from the advertisers to advertise in the target time slot.

5. The method of claim 1, further comprising receiving an image signal from a camera of the digital sign, and obtaining demographic information of viewers of the digital sign by analyzing the image signal.

6. The method of claim 1, wherein when the usage rate is at or above a threshold level, the price for each of the time units in the target time slot is set by an auctioning process, and the advertisers with the highest bids are selected for the time units in the target time slot, and wherein the bids by the advertisers function as the requests to advertise in the target time slot.

7. A method for controlling a digital advertising system comprising an advertising server and at least one digital sign having a plurality of time slots for advertising, the method comprising:
setting an initial price for each of a plurality of time units in a target time slot of the digital sign with reference to at least one of the cost of ownership of the digital sign and the cost incurred to operate the digital advertising system;
facilitating an auctioning process hosted in the advertising server to set an ongoing price for each of the time units in the target time slot and to select advertisers with the highest bids for the time units in the target time slot, the bids from the advertisers being received via a communication network;
generating content packages by the advertising server in response to receiving content segments from the selected advertisers via the communication network wherein each content package includes at least one content segment and metadata related to the content segment; and
transmitting the content packages by the advertising server to the digital sign via the same or a different communication network.

8. The method of claim 7, wherein:
the cost of ownership of the digital sign is determined with reference to at least one of the postal code of where the digital sign is located, the retail price of digital sign, land or real estate rental, land or real estate taxes, and the cost of electricity for the area where the digital sign is located; and
the cost incurred to operate the digital advertising system includes at least one of the cost to store, upload, and download the content segments received from the selected advertisers, operating expenses, and taxes.

9. The method of claim 7, further comprising:
debiting a deposit account of each of the selected advertiser by an amount corresponding to the bid of the selected advertiser; and
crediting a deposit account of digital sign owner by an amount corresponding to a percentage of the bid of each of the selected advertiser.

10. A digital advertising system comprising:
at least one digital sign having a plurality of time slots for presenting advertising; and
an advertising server comprising a processor configured to
set a price for each of a plurality of time units in a target time slot of the digital sign at least with reference to a usage rate,
select advertisers for the time units in the target time slot in response to requests received from the advertisers via a communication network to advertise in the target time slot,
generate content packages in response to receiving content segments from the selected advertisers via the communication network, wherein each content package includes at least one content segment and metadata related to the content segment, and
transmit the content packages to the digital sign via the same or a different communication network,
wherein the usage rate is a function of the time units being used for advertising by advertisers and all the available time units in the target time slot, all the time slots, or a subset of all of the time slots.

11. The digital advertising system of claim 10, wherein the digital advertising system includes a plurality of digital signs, and the usage rate is a function of one of the time units being used for advertising by advertisers and all the available time units in the target time slot, all the time slots, and a subset of all of the time slots for all or a subset of all of the digital signs.

12. The digital advertising system of claim 10, wherein the price of the time units in the target time slot is set at zero when the usage rate is below a threshold level.

13. The digital advertising system of claim 10, wherein the advertising server is further configured to:
obtain information of the digital sign by one or more of probing the digital sign and receiving information from the owner of the digital sign; and
provide the information of the digital sign to advertisers before receiving the requests from the advertisers to advertise in the target time slot.

14. The digital advertising system of claim 10, wherein the advertising server is further configured to receive an image signal from a camera of the digital sign and obtain demographic information of viewers of the digital sign by analyzing the image signal.

15. The digital advertising system of claim 10, wherein when the usage rate is at or above a threshold level, the advertising server is further configured to set the price for each of the time units in the target time slot by an auctioning process, and to select the advertisers with the highest bids for the time units in the target time slot, and wherein the bids by the advertisers function as the requests to advertise in the target time slot.

16. A computer-readable storage medium having computer readable instructions stored thereupon that, when executed by a computer, cause the computer to:
set a price for each of a plurality of time units in a target time slot of the digital sign at least with reference to a usage rate, the plurality of time slots associated with a digital sign in a digital advertising system;
select advertisers for the time units in the target time slot in response to requests received from the advertisers via a communication network to advertise in the target time slot;
generate content packages in response to receiving content segments from the selected advertisers via the communication network, wherein each content package includes at least one content segment and metadata related to the content segment; and
transmit the content packages to the digital sign via the same or a different communication network,
wherein the usage rate is a function of the time units being used for advertising by advertisers and all the available time units in the target time slot, all the time slots, or a subset of all of the time slots.

17. The computer-readable storage medium of claim 16, wherein the digital advertising system includes a plurality of digital signs, and the usage rate is a function of one of the time units being used for advertising by advertisers and all the available time units in the target time slot, all the time slots, and a subset of all of the time slots for all or a subset of all of the digital signs.

18. The computer-readable storage medium of claim 16, wherein the price of the time units in the target time slot is set at zero when the usage rate is below a threshold level.

19. The computer-readable storage medium of claim 16, further comprising computer-readable instructions that, when executed by the computer, cause the computer to:
obtain information of the digital sign by one or more of probing the digital sign and receiving information from the owner of the digital sign; and
provide the information of the digital sign to advertisers before receiving the requests from the advertisers to advertise in the target time slot.

20. The computer-readable storage medium of claim 16, further comprising computer-readable instructions that, when executed by the computer, cause the computer to:
receive an image signal from a camera of the digital sign; and
obtain demographic information of viewers of the digital sign by analyzing the image signal.

21. The computer-readable storage medium of claim 16, wherein when the usage rate is at or above a threshold level, the price for each of the time units in the target time slot is set by an auctioning process, and the advertisers with the highest bids are selected for the time units in the target time slot, and wherein the bids by the advertisers function as the requests to advertise in the target time slot.
